(19) United States
(12) Patent Application Publication
(10) Pub. No.: US 2018/0333230 A1
(43) Pub. Date: Nov. 22, 2018

(54) DENTAL COMPONENT GRIPPING DEVICE

(71) Applicant: P.O.M. Solutions, LLC, Murray, UT (US)

(72) Inventors: Phillip Ray Hansen, Murray, UT (US); Devin Lee Hansen, Murray, UT (US); Scott Tyler Lawson, Murray, UT (US)

(21) Appl. No.: 15/599,418

(22) Filed: May 18, 2017

(51) Int. Cl. A61C 8/00

(52) U.S. Cl. CPC A61C 8/0089; A61C 2201/00; A61C 8/0068; A61C 8/008

(57) ABSTRACT

A dental component gripping device may have an exterior surface with a proximal end, a distal end, and an intermediate region between the proximal end and the distal end, and a bore with a distal portion within the distal end, a proximal portion within the proximal end, and an intermediate portion between the distal portion and the proximal portion. The distal portion may be sized to receive and grip an exterior, proximal surface of at least one dental component such as an abutment, a transfer, and a healing collar. The intermediate portion may have a reduced-diameter zone in which the bore has a diameter smaller than in an entirety of the distal portion. The reduced diameter portion may help to retain a fastener within the distal portion of the bore. The dental component gripping device may be formed of a resilient material such as a Silicon-based material.

### TECHNICAL FIELD

The present disclosure relates to dental implants and related instruments, accessories, and methods. More specifically, the present disclosure relates to dental component gripping devices that can facilitate the attachment of dental implants.

### BACKGROUND

The need to replace teeth is common in dentistry. In many cases, where a natural tooth is lost, decayed, or damaged to such an extent that it cannot be repaired, it will be replaced with a prosthetic tooth (i.e., a “crown”) anchored to the jaw bone (i.e., the mandible or maxilla) via a dental implant that threads into engagement with the bone. The dental implant may be installed in the jaw after removal of the natural tooth, and after the bone has had sufficient time to heal. The dental implant may initially be fitted with a healing collar that keeps the aperture of the dental implant clean as the tissues at the implantation site continue to heal, and as the new crown is custom-made.

Custom-making the crown may involve replacing the healing collar with a transfer and making an impression of the dental anatomy (i.e., teeth and/or gingival tissue, such as gums) surrounding the implantation site. The transfer may be used to secure an analog to the impression; a model of the implantation site may be made from the impression, with the analog in place in the model.

An abutment may be custom-made for the crown, and may be coupled to the model via the analog. The crown may be molded over the abutment. The abutment may be removed from the crown for delivery to the dentist so that the abutment can be attached to the dental implant first, and then the crown can be secured to the abutment to complete replacement of the tooth.

A number of challenges exist due to the small size of parts involved in this process. Some of the dental components, such as the healing collar, transfer, and abutment, need to be secured to the dental implant with the dental implant in place in the bone of the jaw, within the patient's mouth. Thus, the dentist must manipulate these dental components within the patient's mouth, where they can be difficult to grasp. Losing grip on a dental component can result in the dental component falling into the patient's mouth, where it can be swallowed by the patient, or on the floor, where it may become soiled and unsuitable for use. Prior art systems and methods for gripping dental components have not sufficiently solved the difficulties attendant to the use of such dental components.

### SUMMARY

The various systems and methods of the present disclosure have been developed in response to the present state of the art, and in particular, in response to the problems and needs in the art that have not yet been fully solved by currently available dental component gripping systems and methods. The systems and methods of the present disclosure may provide dental component gripping devices and related methods that provide more secure dental component transportation and easier manipulation at the implantation site.

According to some embodiments, a dental component gripping device may be provided to retain a dental component and/or facilitate placement of the dental component at the surgical site. The dental component gripping device may have an exterior surface with a proximal end, a distal end, and an intermediate region between the proximal end and the distal end, and a bore with a distal portion within the distal end, a proximal portion within the proximal end, and an intermediate portion between the distal portion and the proximal portion. The distal portion may be sized to receive and grip an exterior, proximal surface of at least one dental component such as an abutment, a transfer, and a healing collar.

The intermediate portion may have a reduced-diameter zone in which the bore has a diameter smaller than in an entirety of the distal portion. The reduced diameter portion may help to retain a fastener within the distal portion of the bore, as the diameter of the reduced diameter portion may also be less than that of the fastener.

The dental component gripping device may be formed of a resilient material such as a Silicon-based material. The durometer of the dental component gripping device may be carefully selected to give the dental component gripping device sufficient rigidity for proper placement of the dental component, without causing it to be too rigid to deform to the extent needed to receive and grip the dental component. The durometer may be within the range of 40 to 85.

The exterior surface of the dental component gripping device may have flattened regions that facilitate gripping by hand and/or help the distal end of the exterior surface to fit into the implantation site, which may be between adjacent teeth. The distal end of the bore may also have flattened regions that serve to enhance gripping of the exterior, proximal surface of the dental component within the distal end of the bore.

The exterior surface may also have an alignment ridge that facilitates proper alignment of the dental component gripping device, and thence, the associated dental component, with other features such as the dental implant to which the dental component is to be attached, and the surrounding teeth. Additionally or alternatively, the dental component gripping device may be embedded in a matrix contoured to fit over the teeth surrounding the implantation site. Thus, the matrix may be placed on the teeth to automatically dispose the dental implant gripping device, and thence the dental component, in the proper position and orientation.

According to certain methods, a dental component gripping device may be used to facilitate placement of a dental component. According to one method, the dental component gripping device may be positioned proximate an implantation site at which a dental implant is implanted in a jaw bone. The dental component gripping device may include an exterior surface with a proximal end, a distal end, and an intermediate region between the proximal end and the distal end, and a bore with a distal portion within the distal end, that grips an abutment and contains a fastener, a proximal portion within the proximal end, and an intermediate portion within the intermediate region. The intermediate portion may have a reduced-diameter zone in which the bore has a diameter smaller than a largest diameter of the fastener. The method may further include positioning the dental component gripping device such that the abutment o engages the dental implant, inserting a distal interface of a tool through the proximal portion and the intermediate portion such that the distal interface engages the fastener, and manipulating the tool in a manner that causes the fastener to fasten the abutment to the dental implant.

The method may further include, prior to positioning the dental component gripping device proximate the implantation site, inserting the fastener into the distal portion, and inserting an exterior, proximal surface of the abutment into the distal portion by significantly widening the distal portion. After insertion of the exterior, proximal surface into the distal portion, the distal portion may grip the exterior, proximal surface.

The exterior surface may further have an alignment ridge. Positioning the dental component gripping device may include orienting the dental component gripping device such that the alignment ridge is at a predetermined position, visible to a dental practitioner, relative to surrounding teeth, to orient the abutment at a predetermined orientation relative to the dental implant. Additionally or alternatively, the exterior surface may be embedded in a matrix with a distal surface that is custom-shaped to match one or more adjacent teeth. Positioning the dental component gripping device may include positioning the matrix such that the distal surface rests against the one or more adjacent teeth.

According to some embodiments, a dental implant kit may include a dental component gripping device with an exterior surface with a proximal end, a distal end, and an intermediate region between the proximal end and the distal end, and a bore with a distal portion within the distal end, a proximal portion within the proximal end, and an intermediate portion within the intermediate region. The intermediate portion may have a reduced-diameter zone in which the bore has a diameter smaller than in an entirety of the distal portion. The dental implant kit may further include an abutment shaped to secure a crown to a dental implant implanted in a jaw bone, and may have an exterior, proximal surface received within and gripped by the distal portion of the bore. The kit may also include a fastener with which the abutment is attachable to the dental implant. The fastener may reside in the distal portion of the bore. The intermediate portion may be shaped such that the fastener is unable to pass from the distal portion through the intermediate portion, to the proximal portion.

The intermediate portion of the bore may have a reduced-diameter zone with a diameter smaller than a largest diameter of the fastener. The exterior surface and the bore may be defined by a resilient material. Without the abutment in the distal portion, the distal portion may be smaller than the exterior, proximal surface of the abutment such that insertion of the exterior, proximal surface into the distal portion requires significant widening of the distal portion. The resilient material may be a Silicon-based material and has a durometer ranging from 40 to 85.

The exterior surface may have flattened regions on two opposing sides. The flattened regions may facilitate insertion of the dental implant kit into a space between two teeth. The exterior surface may further have an alignment ridge that facilitates visual verification of proper orientation of the dental implant kit relative to one or more adjacent teeth. The abutment may be oriented at a predetermined orientation relative to the alignment ridge.

The distal portion of the bore may have flattened regions on two opposing sides that frictionally retain the abutment within the distal portion. The dental implant kit may further include a matrix in which the exterior surface is embedded. The matrix may have a distal surface that is custom-shaped to match one or more adjacent teeth.

These and other features and advantages of the present disclosure will become more fully apparent from the following description and appended claims, or may be learned by the practice of the systems and methods set forth hereinafter.

### BRIEF DESCRIPTION OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the scope of the appended claims, the exemplary embodiments of the present disclosure will be described with additional specificity and detail through use of the accompanying drawings in which:

FIGS. 1A and 1B are perspective views of a dental component gripping device according to one embodiment.

FIG. 2 is a section view of a dental component gripping device according to one alternative embodiment.

FIGS. 3A and 3B are perspective, section views of the dental component gripping device of FIG. 2, with an abutment retained in the distal portion of the bore.

FIGS. 4A and 4B are perspective, section views of the dental component gripping device of FIG. 2, with a healing collar retained in the distal portion of the bore.

FIGS. 5A and 5B are perspective, section views of the dental component gripping device of FIG. 2, with a transfer retained in the distal portion of the bore.

FIGS. 6A and 6B are exploded perspective, section views of a dental implant, fastener, and tool that may be used with the dental component gripping device of FIG. 2, according to one embodiment.

FIGS. 7A and 7B are perspective, section views of the dental component gripping device of FIG. 1, embedded in a matrix, according to one embodiment.

### DETAILED DESCRIPTION

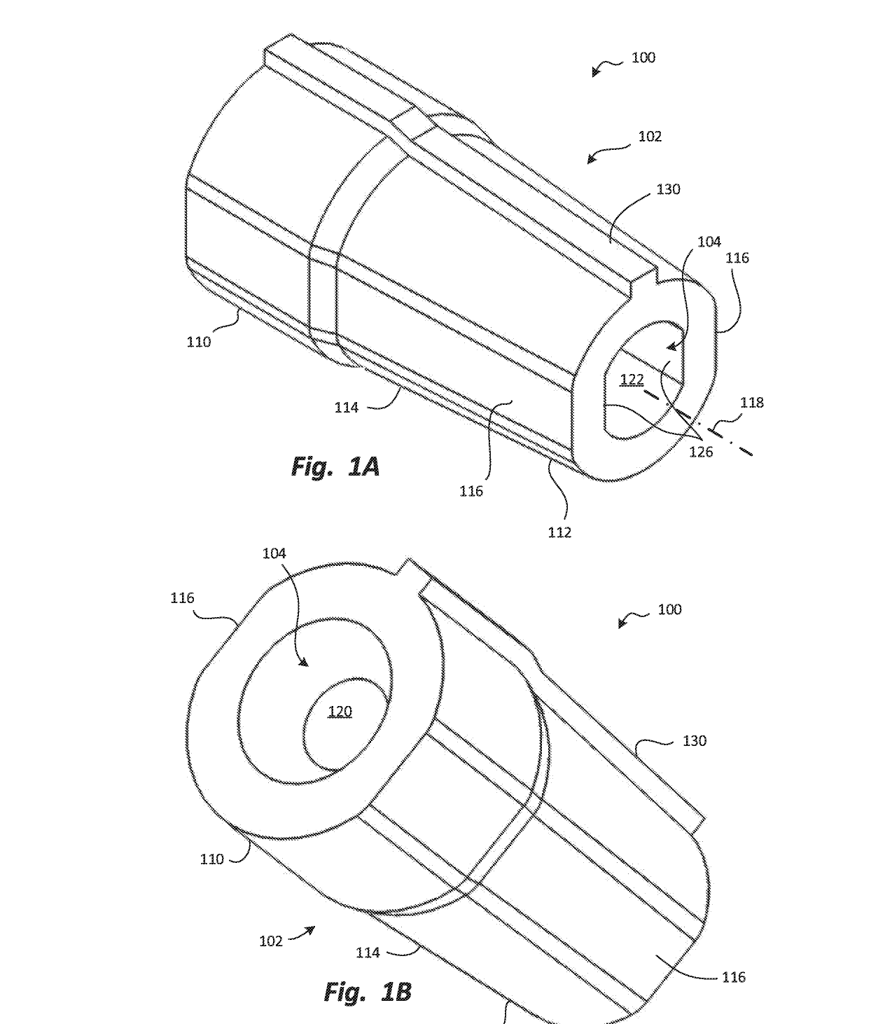

Exemplary embodiments of the disclosure will be best understood by reference to the drawings, wherein like parts are designated by like numerals throughout. It will be readily understood that the components of the disclosure, as generally described and illustrated in the Figures herein, could be arranged and designed in a wide variety of different configurations. Thus, the following more detailed description of the embodiments of the apparatus, system, and method, as represented in FIGS. 1A through 7B, is not intended to limit the scope of the claims, as claimed, but is merely representative exemplary of exemplary embodiments.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

FIGS. 1A and 1B are perspective views of a dental component gripping device 100 according to one embodiment. The dental component gripping device 100 may be designed to retain one or more dental components, such as, but not limited to, abutments, healing collars, and transfers, to facilitate attachment of the dental component(s) to a dental implant implanted in a patient's jaw bone. In some cases, the dental component gripping device 100 may facilitate use of a tool and/or a fastener to help secure the dental component to the dental implant. An exemplary dental implant, abutment, healing collar, transfer, fastener, and tool will all be shown and described subsequently.

As shown, the dental component gripping device 100 may have a generally tubular shape that defines an exterior surface 102 and a bore 104. The exterior surface 102 may have a proximal end 110, a distal end 112, and an intermediate region 114 between the proximal end 110 and the distal end 112. In this application, the terms “proximal” and “distal” are used in relation to the practitioner rather than the patient. Accordingly, “proximal” will refer to parts of an instrument, dental component, or accessory that are closer to the practitioner, and “distal” will refer to parts that are further from the practitioner.

The dental component gripping device 100 may further have a generally frusto-conical shape such that the proximal end 110 is larger than the distal end 112. The exterior surface 102 may further have a pair of flattened regions 116 such that a cross-sectional shape of the exterior surface 102, perpendicular to an axis 118 of the dental component gripping device 100, has a generally circular shape with two flattened, opposing sides. Optionally, the flattened regions 116 may extend along the entire length of the exterior surface 102, from the proximal end 110 to the distal end 112. The flattened regions 116 may serve to facilitate secure gripping of the dental component gripping device 100 with the fingers and/or thumb of a practitioner. Further, the flattened regions 116 may reduce the size of the dental component gripping device 100 in a direction perpendicular to the flattened regions 116, thereby facilitating insertion of the distal end 112 of the dental component gripping device 100 into the relatively narrow implantation site, which may be between two teeth in some cases.

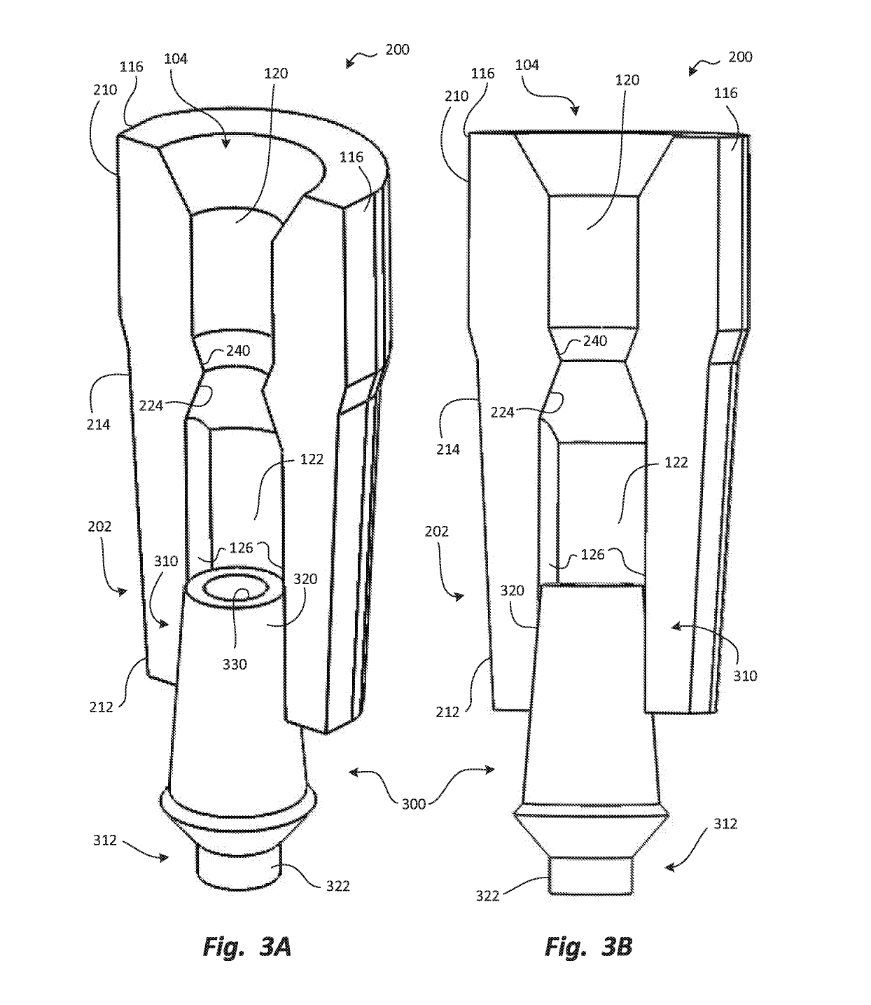

The bore 104 may have a proximal portion 120 within the proximal end 110 of the exterior surface 102, a distal portion 122 within the distal end 112 of the exterior surface 102, and an intermediate portion (visible in FIG. 3) within the intermediate region 114 of the exterior surface 102. The bore 104 may also have a pair of flattened regions 126, which may be positioned on either side of the distal portion 122. The flattened regions 126 may help to grip a portion of a dental component within the distal portion 122 of the bore 104. The flattened regions 126 may cause the bore 104, at the distal portion 122, to have a cross-sectional shape resembling a circle with two flattened, opposing sides. In the embodiment of FIGS. 1A and 1B, the flattened regions 126 may be present only in the distal portion 122, and not in the other portions of the bore 104 (the proximal portion 120 and the intermediate portion).

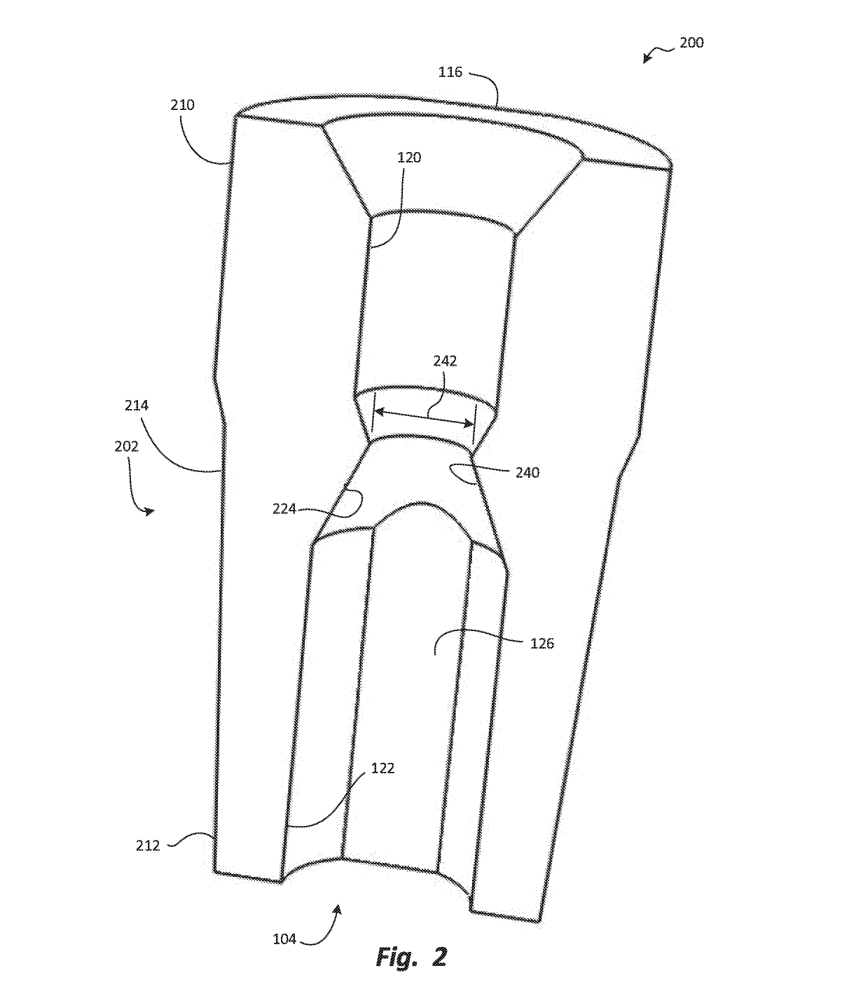

The exterior surface 102 may be shaped to define an alignment ridge 130 that protrudes outward from the remainder of the exterior surface 102, and extends generally parallel to the axis 118 of the dental component gripping device 100. The alignment ridge 130 may help a practitioner easily visualize the orientation of the dental component gripping device 100, and thence, the orientation of a dental component retained in the distal portion 122. This may help the practitioner ensure that the dental component is properly aligned with the implantation zone, the dental implant, and/or surrounding teeth before the dental component is fixed in place in the patient's mouth. According to some examples, the dental component gripping device 100 may be oriented such that the alignment ridge 130 is faces outward, away from the center of the patient's mouth. The alignment ridge 130 is optional; in some embodiments, it may be omitted in favor of other alignment systems. One alternative embodiment lacking an alignment ridge will be shown and described in connection with FIG. 2.

FIG. 2 is a section view of a dental component gripping device 200 according to one alternative embodiment. The dental component gripping device 200 may have an exterior surface 202 with a shape similar to that of the exterior surface 102 of the dental component gripping device 100, except that the exterior surface 202 lacks the alignment ridge 130. Thus, the exterior surface 202 may have a proximal end 210 similar to the proximal end 110, a distal end 212 similar to the distal end 112, and an intermediate region 214 similar to the intermediate o region 114 of the dental component gripping device 100, except that each of these lacks the alignment ridge 130.

The dental component gripping device 200 may have a bore 104 similar to that of the dental component gripping device 100 of FIGS. 1A and 1B. Thus, the bore 104 depicted in FIG. 2 may have a proximal portion 120 and a distal portion 122, as shown in FIGS. 1A and 1B. Further, the bore 104, as shown in FIG. 2, may have an intermediate portion 224 between the proximal portion 120 and the distal portion 122. Like the proximal portion 120, the intermediate portion 224 may lack the flattened regions 126 of the distal portion 122.

The intermediate portion 224 may have a reduced-diameter zone 240 with a diameter 242 selected to prevent passage of certain dental components between the proximal portion 120 and the distal portion 122 of the bore 104. For example, the diameter 242 may be small enough that a fastener contained in the distal portion 122 cannot move through the intermediate portion 224 to reach the proximal portion 120. This will be shown and described in greater detail subsequently.

The dental component gripping device 100 and the dental component gripping device 200 may be formed of a resilient material. A “resilient material” is a material that is capable of relatively high elastic deformation. Most metals, plastics, and ceramics are not resilient materials because under stress, they will experience brittle failure and/or plastic deformation. Many rubber-based and Silicon-based materials can undergo large deflections elastically, and therefore are resilient materials.

According to some examples, the dental component gripping device 100 and/or the dental component gripping device 200 may be made of a Silicon-based material, such as Silicon rubber. The durometer of the material may be carefully selected to enable the dental component gripping device 100 and/or the dental component gripping device 200 to stretch sufficiently at the distal portion 122 of the bore 104 to receive and securely retain the dental component, while remaining sufficiently rigid to generally retain the surface of the exterior surface 102 and the exterior surface 202 while the practitioner is grasping the proximal end 110 or the proximal end 210 and urging the distal end 112 or the distal end 212 to the proper location at the implantation site.

Thus, it may be desirable for the dental component gripping device 100 and/or the dental component gripping device 200 to be formed of a material with a durometer that is not too high and not too low. According to some examples, the durometer may be within the range of 40 to 85. More precisely, the durometer may be within the range of 55 to 80. Yet more precisely, the durometer may be about 75.

As mentioned previously, the dental component gripping device 200 may be used to retain a variety of dental components. If desired, the dental component gripping device 200 may be made in slightly different sizes, durometers, and/or proportions to fit different types of dental components. A color may be used to signify the type of dental component with which the dental component gripping device 200 is to be used. For example, if made to retain an abutment, the dental component gripping device 200 may be red. If made to retain a healing collar, the dental component gripping device 200 may be white. If made to retain a transfer, the dental component gripping device 200 may be blue. Additionally or alternatively, lettering, symbols, and/or other indicators may be used to indicate the type of dental component for which the dental component gripping device 200 is designed.

FIGS. 3A and 3B, 4A and 4B, and 5A and 5B depict the dental component gripping device 200 in use to retain an abutment, a healing collar, and a transfer, respectively. In these exemplary drawings, it is assumed that the same dental component gripping device 200 is used to retain any of these three components. Those of skill in the art will recognize that the dental component gripping device 100 and/or the dental component gripping device 200 may be used to retain other types of dental components. Further, those of skill in the art will recognize that the dental component gripping device 100 and the dental component gripping device 200 are merely exemplary; within the scope of the present disclosure, dental components may be retained with dental component gripping devices that differ from the exemplary embodiments explicitly shown herein.

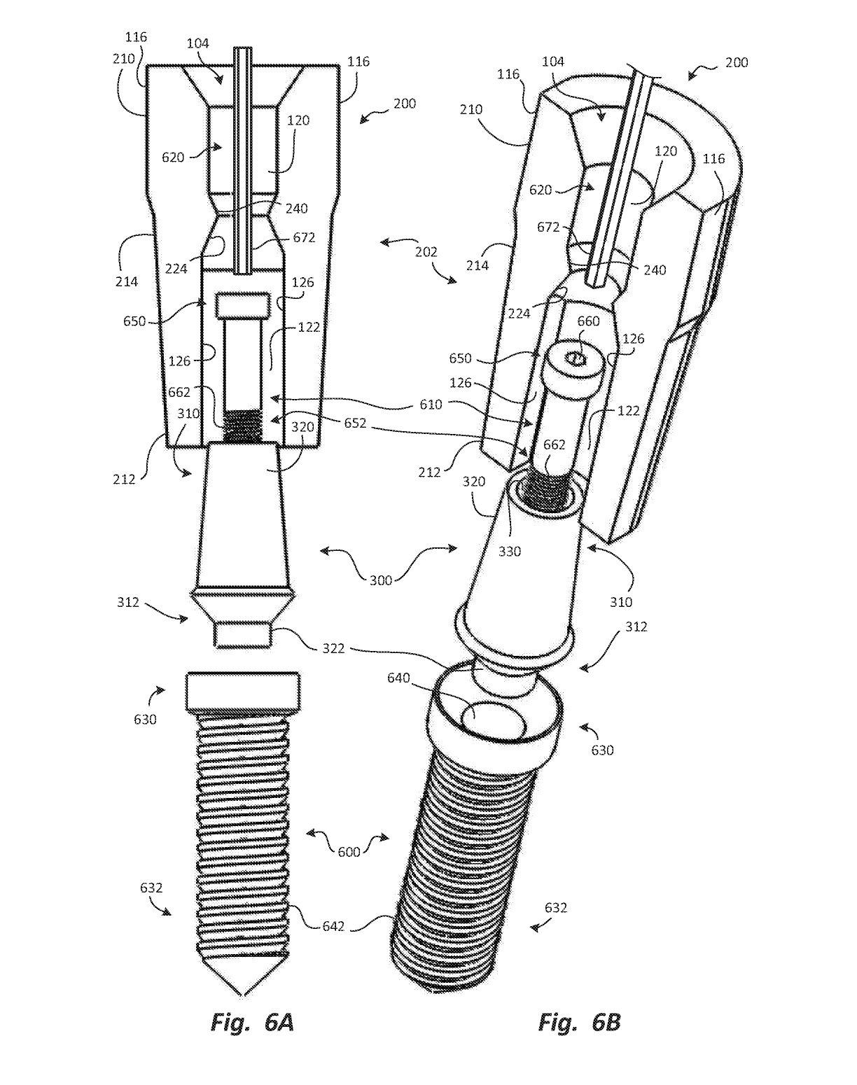

FIGS. 3A and 3B are perspective, section views of the dental component gripping device 200 of FIG. 2, with an abutment 300 retained in the distal portion 122 of the bore 104. The abutment 300 may be used to secure a custom-made crown to a dental implant (shown in FIGS. 6A and 6B) that has already been implanted in the jaw bone of a patient. In some embodiments, the abutment 300 may be custom-made to fit the custom-made crown, and to fit within the space that the crown is to occupy in the patient's mouth.

The abutment 300 may have a proximal end 310 and a distal end 312. The proximal end 310 may have an exterior, proximal surface 320 that is shaped to be received within a corresponding aperture of the crown (not shown). As mentioned previously, the abutment 300 may be custom-made. Thus, the exterior, proximal surface 320 may have a generally conical shape, but this shape may not be predictable, and may thus have various deviations from the generally conical shape. Consequently, it may be advantageous for the distal portion 122 of the bore 104 to be able to deform around the shape of the exterior, proximal surface 320 so that the exterior, proximal surface 320 can be securely retained within the distal portion 122, regardless of any variations that may be present in the shape of the exterior, proximal surface 320.

If desired, the distal portion 122 of the bore 104 may have a generally constant diameter along its length. Thus, the exterior, proximal surface 320 of the abutment 300 may simply be pushed into the distal portion 122 until a large enough portion of the exterior, proximal surface 320 enters the distal portion 122 to enable the exterior, proximal surface 320 to be securely gripped within the distal portion 122. Thus, the dental component gripping device 200 may be able to retain any of a series of differently-sized abutments with relatively constant gripping force. The flattened regions 126 of the distal portion 122 may help enhance gripping by mimicking the operation of fingers applying radial pressure toward each other from opposite sides of the exterior, proximal surface 320.

The distal end 312 of the abutment 300 may have an exterior, distal surface 322 that is shaped to be received within a bore of the dental implant. Thus, the exterior, distal surface 322 may have a generally cylindrical protruding shape. The proximal end 310 of the abutment 300 may further have a bore 330 that extends through the length of the abutment 300 so that a fastener (also shown in FIGS. 6A and 6B) can be inserted into the bore 330 and used to fasten the abutment 300 to the bore of the dental implant.

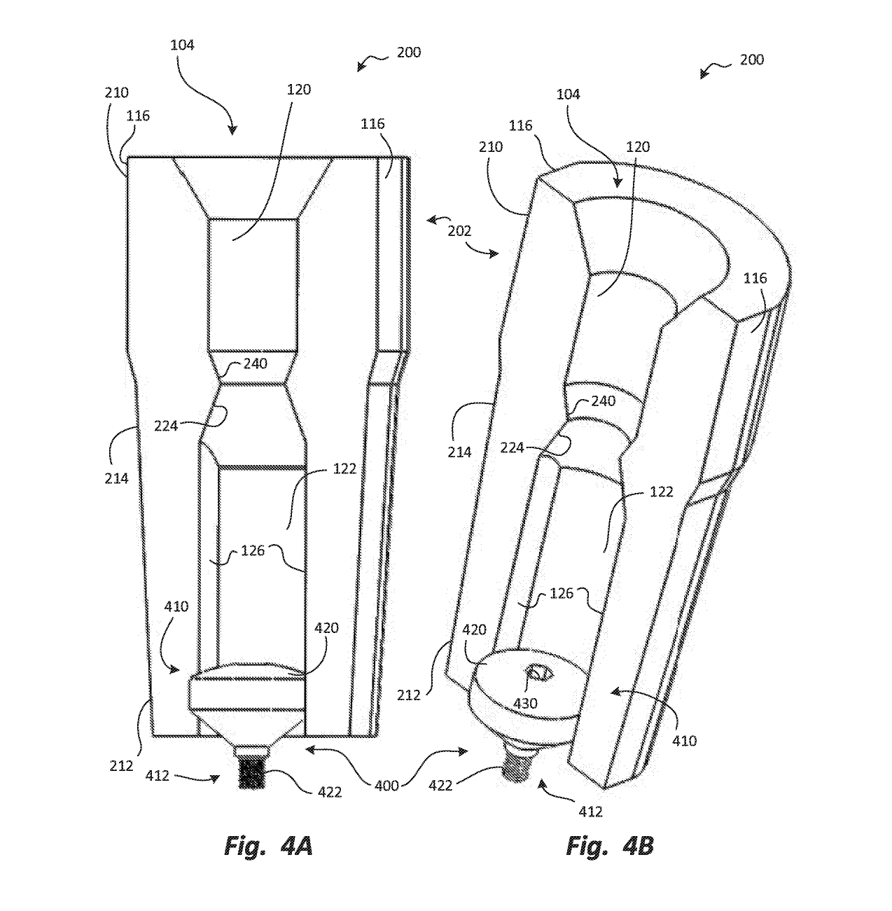

FIGS. 4A and 4B are perspective, section views of the dental component gripping device 200 of FIG. 2, with a healing collar 400 retained in the distal portion 122 of the bore 104. The healing collar 400 may be inserted into the bore of a dental implant (shown in FIGS. 6A and 6B) that has already been implanted in the jaw bone of a patient to facilitate healing of the jaw bone and/or surrounding soft tissues.

The healing collar 400 may have a proximal end 410 and a distal end 412. The proximal end 410 may have an exterior, proximal surface 420 that is shaped to be comfortable to the patient, as it may be exposed within the patient's mouth during healing of the surrounding tissues. The healing collar 400 may have a generally compact shape. Thus, it may be desirable for the dental practitioner to be able to securely retain the exterior, proximal surface 420 within the distal portion 122 of the bore 104 to facilitate the process of positioning the healing collar 400 and securing the healing collar 400 to the dental implant. As with the abutment 300, the flattened regions 126 of the distal portion 122 may help enhance gripping by mimicking the operation of fingers applying radial pressure toward each other from opposite sides of the exterior, proximal surface 420 of the healing collar 400.

The distal end 412 of the healing collar 400 may have an exterior, distal surface 422 that is shaped to be received within a bore of the dental implant. Thus, the exterior, distal surface 422 may have a generally cylindrical protruding shape, which may be threaded to engage the threaded portion of the bore of the dental implant. The proximal end 410 of the healing collar 400 may further have a tool interface 430 with a shape designed to receive a corresponding shape on a tool (also shown in FIGS. 6A and 6B) that can be used to rotate the healing collar 400 into threaded engagement with the threads within the bore of the dental implant. In the example of FIGS. 4A and 4B, the tool interface 430 may have a polygonal shape, such as a hexagonal shape. The distal end of the tool may have a similar shape so that torque can easily be transmitted from the tool to the healing collar 400 via the tool interface 430.

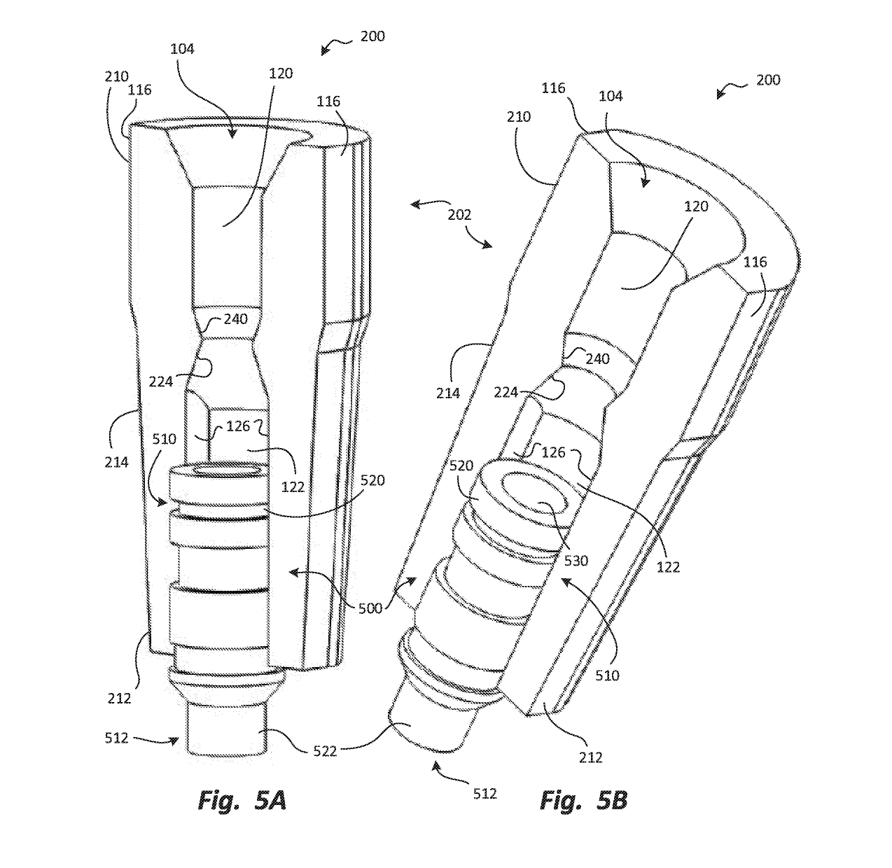

FIGS. 5A and 5B are perspective, section views of the dental component gripping device 200 of FIG. 2, with a transfer 500 retained in the distal portion 122 of the bore 104. The transfer 500 may be inserted into the bore of a dental implant (shown in FIGS. 6A and 6B) that has already been implanted in the jaw bone of a patient to facilitate creation of an impression of surrounding teeth.

The transfer 500 may have a proximal end 510 and a distal end 512. The proximal end 510 may have an exterior, proximal surface 520 that is shaped to receive an analog that will be insert molded into a mold of the surrounding teeth, to be created from the impression. Like the abutment 300 and the healing collar 400, it may be desirable for the dental practitioner to be able to securely retain the exterior, proximal surface 520 within the distal portion 122 of the bore 104 to facilitate the process of positioning the transfer 500 and securing the transfer 500 to the dental implant. As with the abutment 300 and the healing collar 400, the flattened regions 126 of the distal portion 122 may help enhance gripping by mimicking the operation of fingers applying radial pressure toward each other from opposite sides of the exterior, proximal surface 520 of the transfer 500.

The distal end 512 of the transfer 500 may have an exterior, distal surface 522 that is shaped to be received within a bore of the dental implant. Thus, the exterior, distal surface 522 may have a generally cylindrical protruding shape. The proximal end 510 of the transfer 500 may further have a bore 530 that extends through the length of the transfer 500 so that a fastener (also shown in FIGS. 6A and 6B) can be inserted into the bore 530 and used to fasten the transfer 500 to the bore of the dental implant.

The dental component gripping device 100 and/or the dental component gripping device 200 may be used in connection with a wide variety of dental implants, fasteners, and tools. Some exemplary versions are depicted in FIGS. 6A and 6B, by way of example.

FIGS. 6A and 6B are exploded perspective, section views of a dental implant 600, fastener 610, and tool 620 that may be used with the dental component gripping device 200 of FIG. 2, according to one embodiment. The dental component gripping device 200 and the abutment 300 of FIGS. 6A and 6B may be substantially as described previously, in connection with FIGS. 2, 3A, and 3B. The fastener 610, the tool 620, and the head 630 may be of any known type, but are described in exemplary fashion as set forth below.

The dental implant 600 may have a head 630 and a shank 632. The head 630 may have a bore 640 shaped to receive any of various dental components and/or fasteners. In some embodiments, the bore 640 may have a proximal portion (not shown) that is shaped such that the proximal portion can receive the exterior, proximal surface 320 of the abutment 300, the exterior, proximal surface 420 of the healing collar 400, or the exterior, proximal surface 520 of the transfer 500. The bore 640 may further have a distal portion (not shown) with female threads that can receive corresponding male threads of the fastener 610 or the exterior, distal surface 422 of the healing collar 400.

The shank 632 may have threading 642 shaped to anchor the dental implant 600 in a jaw bone of the patient. The threading 642 may have a porous structure or coating, and may, if desired, be coated in a material designed to facilitate bone growth around and/or into the shank 632, such as hydroxyapatite. The threading 642 may be designed, in any case, to securely retain the dental implant 600 in the bone of the patient's jaw (either mandible or maxilla) after the bone has had sufficient time to heal around the dental implant 600.

The fastener 610 may similarly have a head 650 and a shank 652. The head 650 may have a tool interface 660 designed to receive the tool 620 such that the tool 620 can be used to impart torque to the fastener 610. Like the tool interface 430 of the healing collar 400, the tool interface 660 may have a shape designed to receive a corresponding shape on the tool 620, which may be a polygonal shape such as a hexagonal shape. The shank 652 may have threading 662, which may be male threading that interfaces with female threading (not shown) within the distal portion of the bore 640 of the dental implant 600. If desired, the head 650 may be larger than the shank 652 so that the head 650 can engage a countersink or other feature within the bore 330 of the abutment 300, or within the bore 530 of the transfer 500, to enable the fastener 610 to urge the abutment 300 or the transfer 500 against the dental implant 600.

The tool 620 may have a proximal end (not shown) having a handle or other feature that can easily be grasped and rotated by a practitioner. Additionally or alternatively, the proximal end may have a connector that can be used to couple the proximal end to a mechanical driver or other mechanized tool. The tool 620 may further have a shank 672 with a shape corresponding to those of the tool interface 430 of the healing collar 400 and/or the tool interface 660 of the fastener 610 so that torque can easily be transmitted from the shank 672 to the healing collar 400 or the fastener 610.

In use, the dental component gripping device 100 and/or the dental component gripping device 200 may easily be used to facilitate insertion of a dental component such as the abutment 300, the healing collar 400, and/or the transfer 500, into the implantation site and/or attachment of the dental component to the dental implant 600. The dental component may first be coupled to the dental component gripping device 100 or the dental component gripping device 200 by inserting the exterior, proximal surface of the dental component into the distal portion 122 of the bore 104 such that the exterior, proximal surface is gripped by the distal portion 122 of the bore 104. If desired, the fastener 610 may also be inserted into the distal portion 122.

For example, in order to secure the abutment 300 to the dental implant 600, the dental component gripping device 200, the abutment 300, and the fastener 610 may be assembled in the manner depicted to define a kit. Specifically, the shank 652 of the fastener 610 may be inserted into the bore 330 of the abutment 300, and then the exterior, proximal surface 320 of the abutment 300 may be inserted, along with the fastener 610, into the distal portion 122 of the bore 104 of the dental component gripping device 200 until the distal portion 122 securely grips the exterior, proximal surface 320.

The dental component gripping device 200, the abutment 300, and the fastener 610 may thus be coupled together to define a kit that facilitates attachment of the abutment 300 to the dental implant 600 with the fastener 610. The fastener 610 may be retained within the distal portion 122, between the abutment 300 and the intermediate portion 224 of the bore 104, due to the fact that the head 650 of the fastener 610 may have a diameter that is larger than the diameter 242 of the reduced-diameter zone 240 of the intermediate portion 224. Thus, the fastener 610 may be kept in or proximate the bore 330 of the abutment 300 to facilitate use of the fastener 610 to fasten the abutment 300 to the dental implant 600.

The kit may be prepared by the practitioner, or by the maker of the abutment 300. If the maker of the abutment 300 prepares the kit, the maker may custom-fabricate the abutment 300 and then insert it into the distal portion 122 of the bore 104, along with the fastener 610, as described above, and then send the assembled kit to the practitioner. In the alternative, the practitioner may assemble the kit.

When the time comes to use the kit to secure the abutment 300 to the dental implant 600, the practitioner (for example, dentist or oral surgeon) may grasp the dental component gripping device 200 by hand, for example with a thumb and forefinger placed on the flattened regions 116 of the exterior surface 202 of the dental component gripping device 200. The fingers may, for example, be placed on the proximal end 210 of the exterior surface 202 so as to avoid interference with insertion of the distal end 212 into the implantation site.

The practitioner may then position the dental component gripping device 200 such that the exterior, distal surface 322 of the abutment 300 abuts the head 630 of the dental implant 600, and the distal end 212 is at the implantation site to be occupied by the crown (for example, between the surrounding teeth). The practitioner may orient the dental component gripping device 200 such that the abutment 300 assumes the desired orientation relative to the implantation site. This may be done, for example, by aligning one or more markings (not shown) on the dental component gripping device 200 with the surrounding teeth or gums. In the alternative, where the dental component gripping device 100 is used, this may be done by aligning the alignment ridge 130 with the surrounding teeth or gums.

With the distal surface 322 of the abutment 300 aligned with the bore 640 of the dental implant 600, the practitioner may insert the shank 672 of the tool 620 into the proximal portion 120 of the bore 104 of the dental component gripping device 200, and through the intermediate portion 224 of the bore 104, such that the shank 672 engages the tool interface 660 of the fastener 610. The practitioner may then rotate the tool 620 while urging the tool 620 toward the dental implant 600, thereby causing the threading 662 of the fastener 610 to engage the female threading within the bore 640 of the dental implant 600.

The practitioner may continue to rotate the tool 620 until the threading 662 relatively tightly engages the threading (not shown) within the bore 640 to hold the abutment 300 securely in place on the dental implant 600. The practitioner may then withdraw the tool 620 from the dental component gripping device 200, and may pull the dental component gripping device 200 away from the implantation site such that the exterior, proximal surface 320 of the abutment 300 is withdrawn from within the distal portion 122 of the bore 104 of the dental component gripping device 200. The abutment 300 may then be secured to the dental implant 600, in a proper orientation for attachment of the crown (not shown) to the abutment 300.

The transfer 500 may be assembled with the dental component gripping device 200 and the fastener 610 in a manner similar to that set forth above for the abutment 300. The transfer 500 may then be secured to the dental implant 600 in substantially the same way set forth above for the abutment 300.

For the healing collar 400, the fastener 610 need not be used; accordingly, the exterior, proximal surface 420 of the healing collar 400 may be inserted into the distal portion 122 of the bore 104 without the fastener 610 to define a kit consisting of just the dental component gripping device 200 and the healing collar 400. The exterior, distal surface 422 of the healing collar 400 may be placed against the dental implant 600 and the shank 672 of the tool 620 may be inserted through the proximal portion 120 and the diameter 242 of the bore 104 to engage the tool interface 430 of the healing collar 400. The tool 620 may then be rotated in order to rotate the healing collar 400 such that the threads of the exterior, distal surface 422 of the healing collar 400 engage the threads (not shown) within the bore 640 of the dental implant 600. Then, the tool 620 and the dental component gripping device 200 may be withdrawn from the healing collar 400, leaving the healing collar 400 secured to the dental implant 600 at the implantation site.

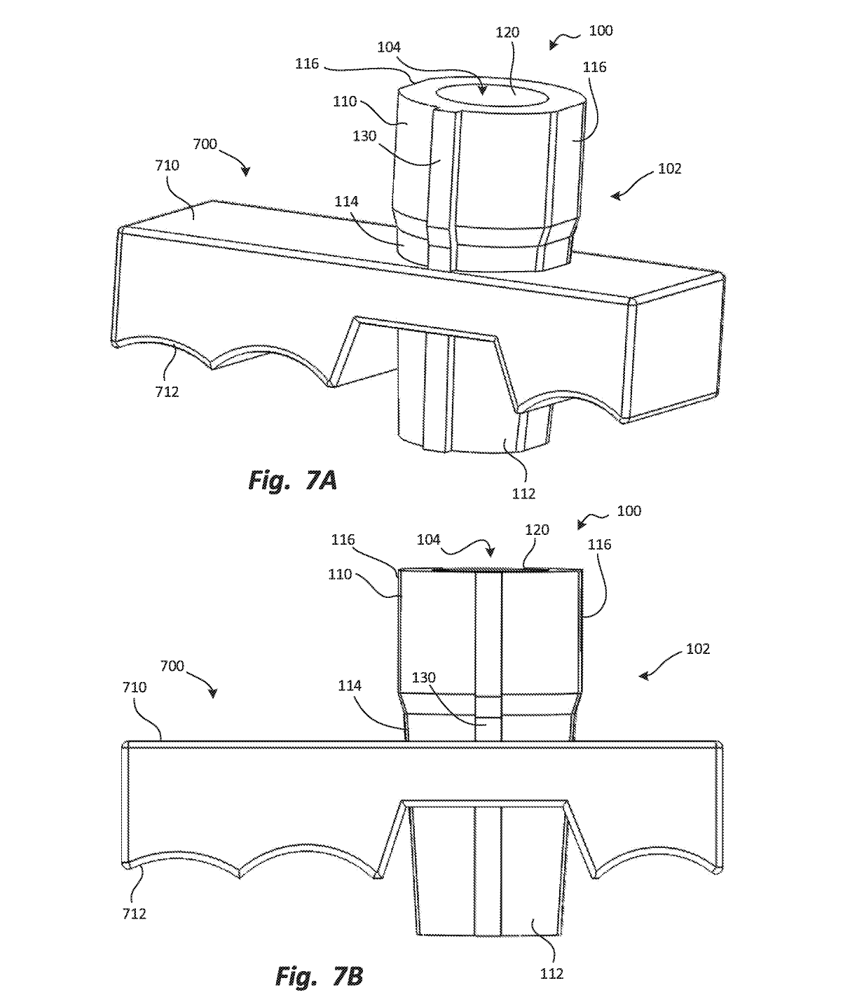

As mentioned previously, the alignment ridge 130 may be used to facilitate alignment of the dental component gripping device 100 relative to surrounding teeth. Where the dental component gripping device 200 is used instead, various other markings or indicia may be used, if needed. In the alternative to the foregoing, the dental component gripping device 100 or the dental component gripping device 200 may be embedded in a matrix that facilitates proper orientation of the dental component gripping device 100 or the dental component gripping device 200 relative to surrounding teeth. One exemplary embodiment showing use of such a matrix will be shown and described in connection with FIGS. 7A and 7B.

FIGS. 7A and 7B are perspective, section views of the dental component gripping device 100 of FIG. 1, embedded in a matrix 700, according to one embodiment. As mentioned previously, an impression may be made of the teeth surrounding an implantation site. The impression may be used to make a mold that facilitates custom-fabrication of a crown that fits the implantation site. The matrix 700 may be made, for example, as an impression of the mold. Accordingly, the matrix 700 may be custom-fabricated to fit the teeth surrounding the implantation site.

Thus, the matrix 700 may have a proximal surface 710 having an arbitrary shape, and a distal surface 712 that is contoured to fit the teeth surrounding the implantation site. The dental component gripping device 100 may be embedded in the matrix 700 such that the distal end 112 of the exterior surface 102 protrudes beyond the distal surface 712, and the proximal end 110 of the exterior surface 102 protrudes beyond the proximal surface 710. The dental component gripping device 100 may be embedded at such a position that, with the distal surface 712 lying on the teeth it is contoured to fit, the dental component gripping device 100 is at the proper depth to cause the dental component (for example, the abutment 300) retained by the dental component gripping device 100 to engage the dental implant 600.

The contouring of the distal surface 712 may cause the matrix 700 to fit onto the teeth surrounding the implantation site in only one orientation and position. Thus, the matrix 700 may make usage of the alignment ridge 130 unnecessary. Positioning the matrix 700 on the teeth surrounding the implantation site may cause the dental component gripping device 100, and thence the dental component retained by the dental component gripping device 100, to be oriented and positioned properly. The matrix 700 may be used in connection with any dental component gripping device according to the present disclosure, including but not limited to the dental component gripping device 100 and the dental component gripping device 200. The matrix 700 may be used in addition to or in place of other orientation and/or positioning indicia, such as the alignment ridge 130 of the dental component gripping device 100.

In some embodiments, the matrix 700 may be made by the same person or entity that custom-fabricates the crown and/or the abutment 300. The matrix 700 may be included in a kit that includes, at least, a dental component gripping device (such as the dental component gripping device 100 or the dental component gripping device 200), the matrix 700, and the dental component to be retained. Other elements, such as the fastener 610, may also be included in such a kit, as described previously.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. §112 Para. 6. It will be apparent to those having skill in the art that changes may be made to the details of the above-described embodiments without departing from the underlying principles set forth herein.

While specific embodiments and applications of the present disclosure have been illustrated and described, it is to be understood that the scope of the appended claims is not limited to the precise configuration and components disclosed herein. Various modifications, changes, and variations which will be apparent to those skilled in the art may be made in the arrangement, operation, and details of the methods and systems disclosed herein.

What is claimed is:

1. A dental component gripping device comprising:
an exterior surface comprising a proximal end, a distal end, and an intermediate region between the proximal end and the distal end; and
a bore comprising:
a distal portion within the distal end, wherein the distal portion is sized to receive and grip an exterior, proximal surface of at least one dental component from the group consisting of:
an abutment shaped to secure a crown to a dental implant implanted in a jaw bone;
a transfer shaped to reside in a dental implant during creation of an impression; and
a healing collar attachable to the dental implant to facilitate healing of gingival tissue;
a proximal portion within the proximal end; and
an intermediate portion within the intermediate region, the intermediate portion comprising a reduced-diameter zone in which the bore has a diameter smaller than in an entirety of the distal portion.

2. The dental component gripping device of claim 1, wherein:
the dental component comprises the abutment;
the abutment is attachable to the dental implant with a fastener; and
the diameter of the bore in the reduced-diameter zone is smaller than a largest diameter of the fastener.

3. The dental component gripping device of claim 1, wherein:
the exterior surface and the bore are defined by a resilient material; and
the distal portion is smaller than the exterior, proximal surface of the dental component such that insertion of the exterior, proximal surface into the distal portion requires significant widening of the distal portion.

4. The dental component gripping device of claim 3, wherein the resilient material comprises a Silicon-based material and has a durometer within a range of 40 to 85.

5. The dental component gripping device of claim 1, wherein the exterior surface comprises flattened regions on two opposing sides, wherein the flattened regions facilitate insertion of the dental component gripping device into a space between two teeth.

6. The dental component gripping device of claim 1, wherein the exterior surface comprises an alignment ridge that facilitates visual verification of proper orientation of the dental component gripping device relative to one or more adjacent teeth.

7. The dental component gripping device of claim 1, wherein the distal portion of the bore comprises flattened regions on two opposing sides to facilitate frictional retention of the dental component within the distal portion.

8. The dental component gripping device of claim 1, further comprising a matrix in which the exterior surface is embedded, the matrix comprising a distal surface that is custom-shaped to match one or more adjacent teeth.

9. A method comprising:
positioning a dental component gripping device proximate an implantation site at which a dental implant is implanted in a jaw bone, wherein the dental component gripping device comprises:
an exterior surface comprising a proximal end, a distal end, and an intermediate region between the proximal end and the distal end; and
a bore comprising:
a distal portion within the distal end, wherein the distal portion grips an abutment and contains a fastener;
a proximal portion within the proximal end; and
an intermediate portion within the intermediate region, the intermediate portion comprising a reduced-diameter zone in which the bore has a diameter smaller than a largest diameter of the fastener;
further positioning the dental component gripping device such that the abutment engages the dental implant;
inserting a distal interface of a tool through the proximal portion and the intermediate portion such that the distal interface engages the fastener; and
manipulating the tool in a manner that causes the fastener to fasten the abutment to the dental implant.

10. The method of claim 9, further comprising, prior to positioning the dental component gripping device proximate the implantation site:
inserting the fastener into the distal portion; and
inserting an exterior, proximal surface of the abutment into the distal portion by significantly widening the distal portion such that, after insertion of the exterior, proximal surface into the distal portion, the distal portion grips the exterior, proximal surface.

11. The method of claim 9, wherein:
the exterior surface comprises an alignment ridge; and
positioning the dental component gripping device comprises orienting the dental component gripping device such that the alignment ridge is at a predetermined position, visible to a dental practitioner, relative to surrounding teeth, to orient the abutment at a predetermined orientation relative to the dental implant.

12. The method of claim 9, wherein:
the exterior surface is embedded in a matrix comprising a distal surface that is custom-shaped to match one or more adjacent teeth; and
positioning the dental component gripping device comprises positioning the matrix such that the distal surface rests against the one or more adjacent teeth.

13. A dental implant kit comprising:
a dental component gripping device comprising:
an exterior surface comprising a proximal end, a distal end, and an intermediate region between the proximal end and the distal end; and
a bore comprising:
a distal portion within the distal end;
a proximal portion within the proximal end; and
an intermediate portion within the intermediate region, the intermediate portion comprising a reduced-diameter zone in which the bore has a diameter smaller than in an entirety of the distal portion;
an abutment shaped to secure a crown to a dental implant implanted in a jaw bone, the abutment comprising an exterior, proximal surface received within and gripped by the distal portion of the bore; and
a fastener with which the abutment is attachable to the dental implant, the fastener residing in the distal portion of the bore;
wherein the intermediate portion is shaped such that the fastener is unable to pass from the distal portion through the intermediate portion, to the proximal portion.

14. The dental implant kit of claim 13, wherein the intermediate portion of the bore comprises a reduced-diameter zone with a diameter smaller than a largest diameter of the fastener.

15. The dental implant kit of claim 13, wherein:
the exterior surface and the bore are defined by a resilient material; and
without the abutment in the distal portion, the distal portion is smaller than the exterior, proximal surface of the abutment such that insertion of the exterior, proximal surface into the distal portion requires significant widening of the distal portion.

16. The dental implant kit of claim 15, wherein the resilient material comprises a Silicon-based material and has a durometer within a range of 40 to 85.

17. The dental implant kit of claim 13, wherein the exterior surface comprises flattened regions on two opposing sides, wherein the flattened regions facilitate insertion of the dental implant kit into a space between two teeth.

18. The dental implant kit of claim 13, wherein the exterior surface comprises an alignment ridge that facilitates visual verification of proper orientation of the dental implant kit relative to one or more adjacent teeth, wherein the abutment is oriented at a predetermined orientation relative to the alignment ridge.

19. The dental implant kit of claim 13, wherein the distal portion of the bore comprises flattened regions on two opposing sides that frictionally retain the abutment within the distal portion.

20. The dental implant kit of claim 13, further comprising a matrix in which the exterior surface is embedded, the matrix comprising a distal surface that is custom-shaped to match one or more adjacent teeth.
